(19) United States
(12) Patent Application Publication
(10) Pub. No.: US 2015/0158611 A1
(43) Pub. Date: Jun. 11, 2015

(54) VARIABLE PITCH PACKAGING APPARATUS AND METHODS

(71) Applicant: R. A Jones & Co.

(72) Inventors: Robert M. Kalany, Florence, KY (US); John V. Catalano, Crescent Springs, KY (US); Kevin Krieg, Cincinnati, OH (US)

(21) Appl. No.: 14/563,198

(22) Filed: Dec. 8, 2014

Related U.S. Application Data
(60) Provisional application No. 61/912,658, filed on Dec. 6, 2013.

(51) Int. Cl. B65B 35/50; B65G 47/26; B65B 35/24

(52) U.S. Cl. CPC B65B 35/50; B65B 35/24; B65G 47/26

(57) ABSTRACT

Packaging apparatus includes, in combination, a product receiving or loading station requiring individual product buckets oriented at one pitch for loading with products and a cartoning station requiring groups of buckets oriented at another different pitch for packaging articles into cartons. The apparatus accommodates the packaging of varying numbers of buckets or product stacks in varied width cartons, independent of the orientation of buckets in the product receiving station. Buckets are conveyed in a path through the packaging apparatus under the influence of a linear motor conveyor independently of, and separate from, other buckets in the path and without regard to pitch between other buckets in the path. Apparatus and methods are disclosed.

### PRIORITY CLAIM

Application claims the benefit of the filing date of Dec. 6, 2013 of U.S. Provisional Patent Application, Ser. No. 61/912,658, which is incorporated herein by reference.

### FIELD OF THE INVENTION

This invention relates to packaging of articles and more particularly to apparatus and methods for packaging articles in a wide variety of article count and final groupings for cartoning.

### BACKGROUND OF THE INVENTION

In packaging equipment it is common and necessary to deposit stacks of articles, such as pouches, into article buckets which are then conveyed to transport the stacks to a loading apparatus where the stacks of pouches are loaded into packages, such as cartons. The stack counts and the number of stacks that are loaded into a single carton will vary.

More particularly, it will be appreciated that the positional requirements of the article buckets at product receipt and then carton loading are not always equal. In the past, with a fixed pitch article bucket conveyor, the bucket pitch at receipt had to be equal to the bucket pitch at carton loading. This is often not desirable, such as when the contents of several buckets must be inserted into one carton, requiring the buckets or separate groups thereof to be spaced differently upon cartoning than when receiving products or product stacks.

Several methods are previously known; one such method uses article buckets which are conveyed on an untimed or so-called “floating bucket” conveyor between product receipt and carton loading. Prior to the empty buckets arriving at product receipt, the buckets are queued up ahead of a metering section as the floating bucket or untimed conveyor continues to run beneath the buckets driving them in the direction of the metering section. Once at the metering section the buckets are engaged by lugs that drive the buckets in time through the product receipt area where the product is fed into the buckets. Once the buckets are loaded they are released from the metering lugs and once again conveyed by the floating bucket or untimed conveyor. The filled buckets arrive at a second queue just ahead of carton loading. In a manner similar to bucket loading at the product receipt area, the queued, now filled, buckets are driven into a metering section by the floating bucket or untimed conveyor where metering lugs engage the buckets and drive them in a timed manor through carton loading. The metering or bucket pitch and pattern at carton loading can and often is different than that at bucket loading. Once the product has been loaded in the cartons the buckets are released from the metering lugs and the empty buckets are once again conveyed by the floating bucket conveyor to repeat the process. The untimed-timed-untimed-retimed nature of this method, requiring that buckets be queued and metered has some rate and flexibility drawbacks. Bucket queues on untimed free running conveyors, by their very nature, will have buckets colliding with one another resulting in some abrupt accelerations and uncontrolled behavior. This is detrimental to product handling including the handling of pouches and of articles susceptible to damage from rough handling.

As further background, the following U.S. patents are herewith incorporated herein by express references if fully set forth and expressed herein:
U.S. Pat. No. 7,134,258 B2 Kalany et al.; and
U.S. Pat. No. 5,575,187 Dieterlen.

### SUMMARY OF THE INVENTION

The invention in a preferred embodiment contemplates apparatus and methods for filling an article bucket with articles to be packaged on a pitch suitable for the receipt of product from a variable count direct drop knife such as that in U.S. Pat. No. 5,575,187 and subsequently adjusting the pitch and grouping of the filled article buckets on a conveyor, referred to as a pitch-less conveyor, to a pitch and grouping defined by the carton size and transfer guide pitch via the combination of a bucket conveyor operable to drive buckets in a common path but wholly independent of position of other buckets in the path.

This invention thus contemplates the combination of a “pitch-less” conveyor, defined as an article bucket conveyor system where each article bucket can move in a common path but independent of every other bucket traveling in a single path, free of collisions with other buckets, completely flexible, and without extraneous bucket metering devices at respective stations, together in a packaging system where product loading and product cartoning operation require different systems pitch.

Through the application of independently controlled moving magnet linear motors, article buckets are programmed to move independent of one another in a single path, providing a pitch-less conveying system capable of performing differently and positioning buckets in different pitches at respective product receipt and carton loading. The benefits of such a system are numerous, such as higher speeds, greater through put, smaller foot print, lower accelerations, greater flexibility, lower change over times, improved conversion reliability, reduced scrap and greater up time.

Since the moving elements on bucket assemblies are independently controlled, the article buckets can be programmed to move in a non-linear fashion to optimize it's synchronization with an adjacent process. For example, the bucket can be slowed and grouped at short pitch as the pouches are transferred to a variable count direct drop knife so to increase the time available for the product drop thus providing for higher stack counts than are achievable by a fixed pitch constant velocity conveyor. At the same time, such a conveyor is capable of providing grouping combinations of buckets arriving at a cartoning station independently of initial bucket pitch and loading movement at a receiving station.

In more detail, this invention is comprised of an oval track of linear motors with a plurality of independently driven carts to which article buckets are mounted. Each cart and article bucket assembly is independently controlled to move in a common path with a plurality of other cart and bucket assemblies, but wholly independent of movement or pitch of other buckets in the path. FIGS. 1 through 3 illustrate article buckets programmed to receive articles such as pouches from the direct drop knife at a constant bucket pitch where the spacing between the buckets is constant and small. It should be noted that the pouch transfer wheel or knife with variable count capability requires that the bucket spacing be constant and as small as possible. The FIGS. 1-3 then illustrate articles in stacks of separate groupings, in different pitches corresponding to cartons to be filled.

### BRIEF DESCRIPTION OF THE DRAWINGS

FIG. 1 is an isometric view of the invention including a variable count direct deposit knife, a pouch feeder, linear motor conveyor and cartoning area, with buckets or bucket groups at different pitch between knife and cartoning area, and illustrates product stacks from three buckets inserted into a single carton;

FIG. 2 is a view similar to FIG. 1 but illustrating product stacks from two buckets placed in a single carton;

FIG. 3 is a view similar to FIGS. 1 and 2 but illustrating a single product stack placed in a single carton;

FIG. 4A is an illustrative top plan view of the embodiment of FIG. 1;

FIG. 4B is an illustrative elevational view of the embodiment of FIGS. 1 and 4A;

FIG. 5 is an enlarged view of the encircled area of FIG. 4B;

FIG. 6 is an enlarged view of the encircled area of FIG. 4A; and

FIG. 7 is an isometric enlarged view of a bucket and bucket cart of the FIGS. 1-6.

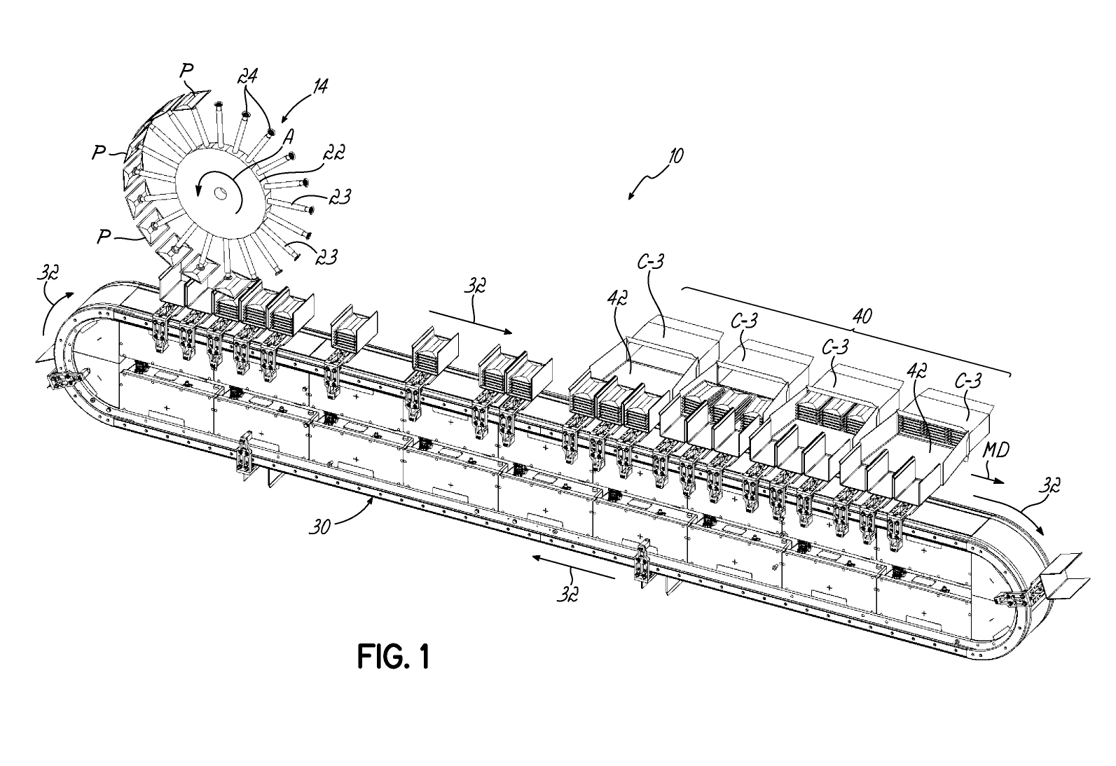

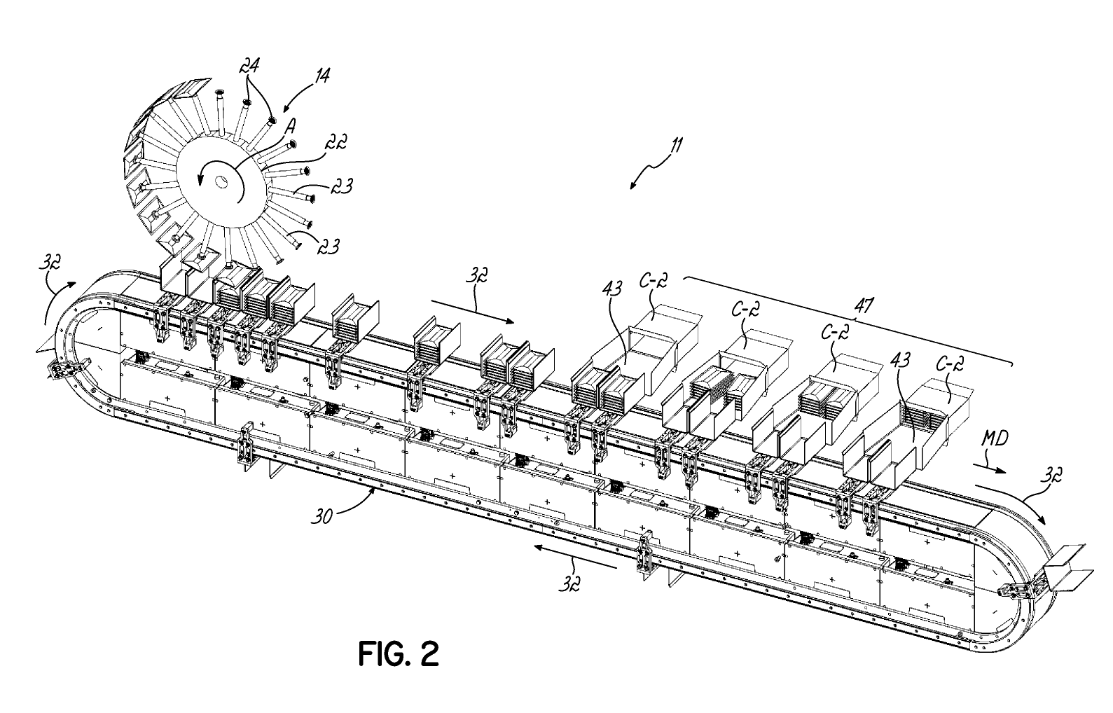

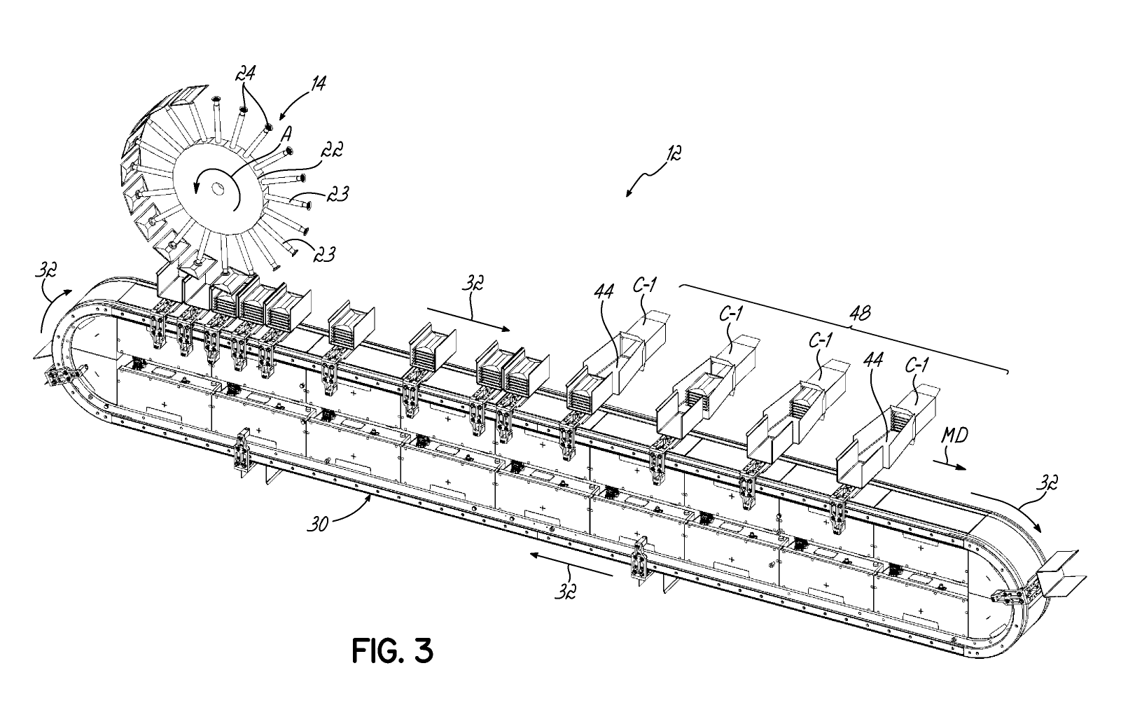

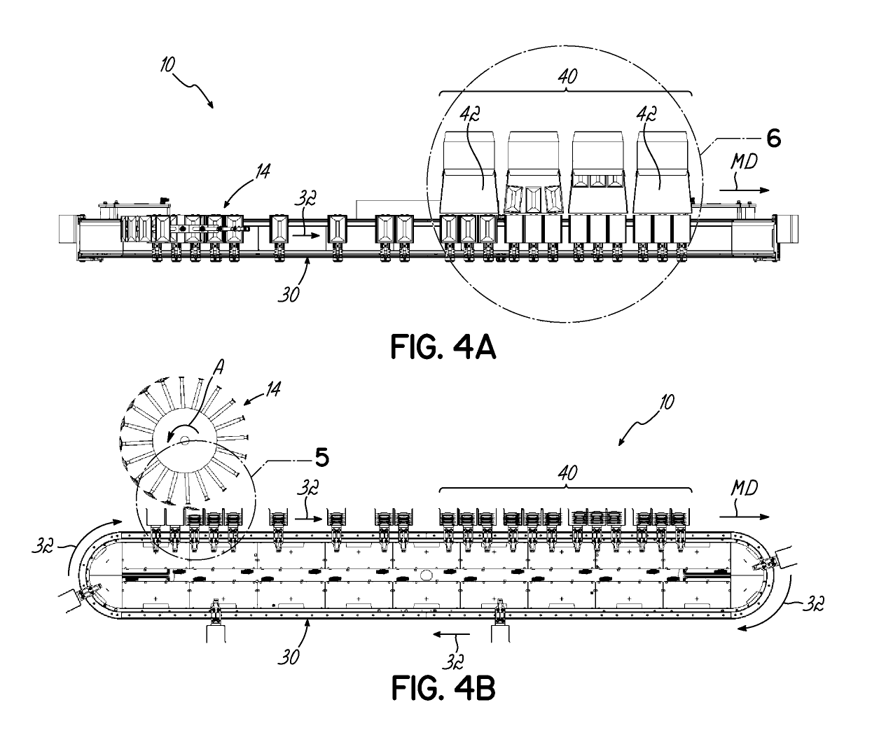

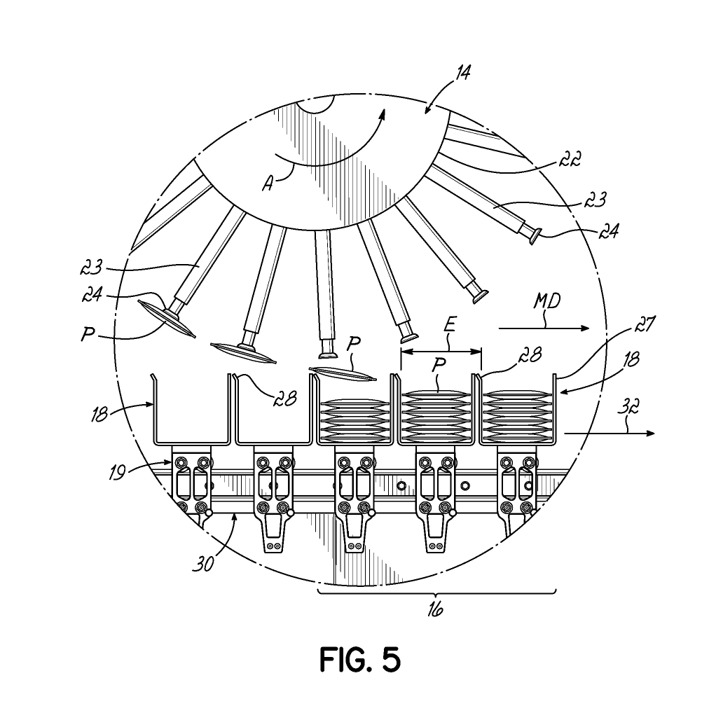

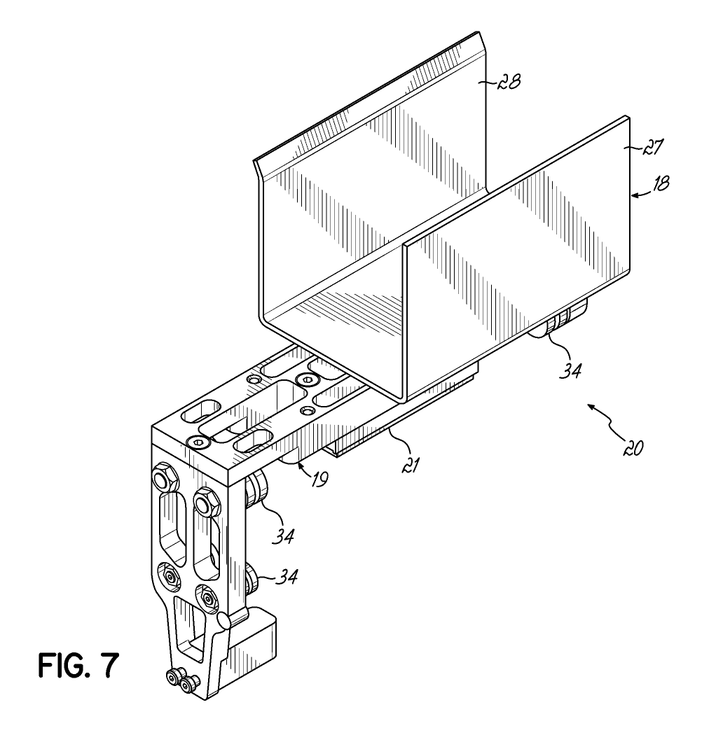

Turning now to the Figures, there are shown cartoning systems according to the invention in several different embodiments (10, 11 and 12 respectively), as in respective FIGS. 1-7. FIGS. 1, 4, 4B and 6 illustrate what is referred to as a three-stack packaging apparatus 10. FIG. 2 illustrates a two-stack packaging apparatus 11, and FIG. 3 illustrates a single stack packaging apparatus 12. FIG. 5 illustrates features of a variable count direct deposit knife 14 at a product loading or product receiving station 16, common generally to all three embodiments 10, 11 and 12. FIG. 7 illustrates a bucket 18 and cart 19 assembly 20 common to all embodiments 10, 11 and 12.

Variable count direct deposit knife 14 is as described in U.S. Pat. No. 5,575,187, incorporated herein by express reference and as if fully set out expressly herein. Suffice to say, knife 14 in all embodiments 10, 11, and 12 includes a rotary hub 22 carrying a plurality of vertically extending suction cup holders 23 conveying suction cups 24 for movement in a circular path as hub 22 turns counterclockwise in the direction of arrow A as viewed in FIGS. 1, 2, 3, 4B and 5. Articles such as pouches P are introduced to and carried by certain cups 24 from a suitable entry station to a product load station 16 (FIG. 5) in each embodiment.

While particular cutting elements of knife 14 are detailed in U.S. Pat. No. 5,575,187, and are not shown here in the Figures, pouches in the form of an elongated, uncut train or bandolier are fed to knife 14 which is operable to separate individual pouches P for dropping at load station 16 into buckets 18, as will be appreciated and consistent with the disclosure of U.S. Pat. No. 5,575,187.

As well, it will be appreciated that rotary feeding of pouches in the same situational orientation would be accomplished without any knife function where individual precut pouches are transferred and dropped or deposited as shown herein.

Such knife 14, as noted above is attended by certain operational limitations. With particular reference to FIG. 5, as pouches P are transferred in a circular pattern for dropping into buckets it is appreciated that the buckets must be adjacent and at a constant or fixed pitch so each can be loaded with a plurality of articles or pouches, which in this case is six in number. As the hub 22 rotates, pouches P are released at pre-timed points so that as buckets 18 move in a machine direction MD, the speed of knife 14 and the release points are such that the buckets are filled by the time they leave the product load station 16.

In such apparatus, there is no way to deposit pouches into buckets unless the buckets are fixed at contact pitch. Otherwise, pouches P could be dropped into areas with no buckets to receive them, requiring rejection or waste.

As shown in FIG. 5, the buckets 18 have lead walls 27 and trailing walls 28. For purposes of this application, a bucket “pitch” is defined as the distance “E” between two trailing walls of respective adjacent buckets.

It will be further appreciated that, as shown in FIG. 7, each bucket/cart assembly 20 also includes a magnet 21 for operation with respect to a linear motor conveyor 30 as described in U.S. Pat. No. 7,134,258 incorporated expressly herein. Such a conveyor is programmed and designed to move independent assemblies 20 along a common path 32, but entirely independent of other assemblies 20 in path 32.

As a result, buckets 18 can be grouped at a constant fixed pitch and motion through station 16 (FIG. 5) despite and independent of position and speed of other assemblies 20 in other portions of path 32.

Thus respecting FIG. 5, assemblies 20 are operated in constant pitch E through station 16 for constant loading of articles such as pouches P into buckets 18.

With further reference to FIG. 7, it will be appreciated brackets or carts 19 are mounted on conveyor 30 by any suitable means such as rollers 34.

Turning to FIGS. 1-3 and 4, it will be appreciated that the embodiments of 10, 11, and 12 each include a cartoning station 40 where one or more stacks of products P are inserted into cartons such as one-stack cartons C-1 (FIG. 3), two stack cartons C-2 (FIG. 2) and three-stack cartons C-3 (FIG. 1). Of course, it will be appreciated that other product groupings of more stacks or other size products can be accommodated, FIGS. 1-3 illustrating several embodiments for illustration only and not limitation.

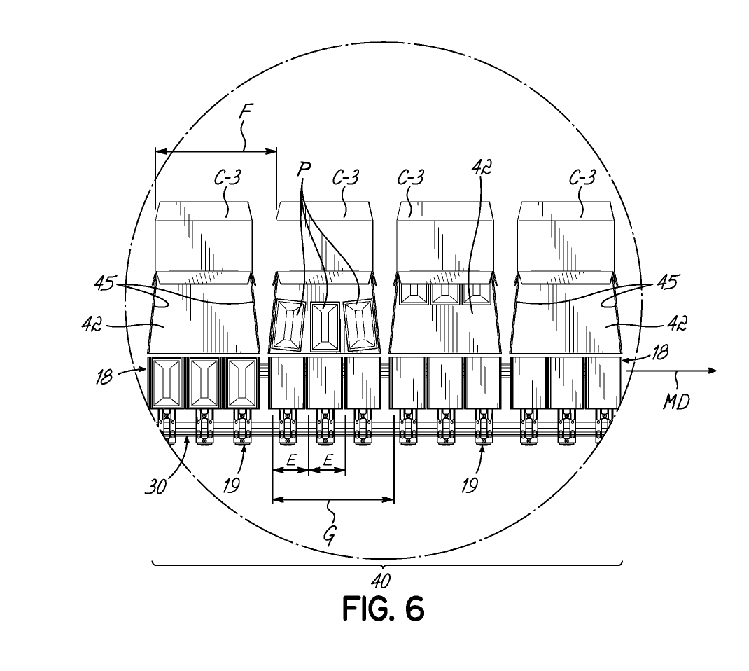

In this regard, it will be appreciated that the respective cartons are conveyed by or via a carton conveyor, at programmed pitch F (FIG. 6) adjacent and parallel to conveyor 30 for receiving the formed groups of products. Intermediate transfers or guides 42, 43, 44 are operably interposed for transferring products into the respective cartons C-1, C-2 or C-3. These guides form transfers at the same pitch as the respective cartons, and products are moved or slid over these guides for introduction into the respective cartons. To aid in this, guides 42, 43, 44 each have tapered walls 45 as shown for directing and confining these products and product stacks introduced, for example, by the opening between buckets 18 of a product grouping.

Turning to FIGS. 1, 4A, 4B and 6, a three-stack cartoning apparatus is illustrated where successive groups of three stacks each of product are grouped in cartoning station 40 at a group pitch equal to that of the adjacent cartons. Each group of three product stacks are set at a pitch G (FIG. 6) with each bucket in a group at a bucket pitch E respecting a preceding bucket 18 in that group.

In FIG. 2, the products are grouped into groups of two product stacks by two buckets 18, for cartoning at station 47.

In FIG. 3 the products are grouped in single groups, each for single stack in a single bucket for conforming at station 48.

Accordingly, the cartons C-1, C-2, C-3 are positioned on the carton conveyor (not shown) at a constant pitch F, such as that shown in FIG. 6. It will be appreciated the pitch of the cartons at cartoning stations 40, 47 and 48 is equal, even though the space between cartons in embodiments 10, 11 and 12 differs due to the carton size (width) in the machine directional MD. In this regard, the carton pitch F is defined as a distance between the trailing edge of one carton to the trailing edge of the preceding or succeeding carton.

Any suitable mechanism such as a barrel loader (not shown) or other devices can be used to transfer items and article stacks from the buckets, across the guides and into the cartons of embodiments 10, 11, and 12. Accordingly, it will be appreciated that product load or deposit into the buckets requires the buckets be on constant pitch at constant speed while product cartoning requires grouping of respective buckets with pitch of the bucket groups the same as each other, but with different numbers of buckets in the group depending on the desired cartoning of the contents of one or more buckets into respective cartons.

In this connection, it will be appreciated the invention in whichever embodiment provides significantly more flexibility and speed than in such prior system or the prior floating bucket system as described above.

The same apparatus can be used in cartoning items in one or more stacks into cartons of varied width and with any programming and perhaps guide changes, the invention providing and accommodating different bucket spacing requirements at the product load end than the specific bucket groupings required at the other cartoning end.

In use, buckets 18 are brought beneath knife 14, by operation of conveyor 30 at a fixed constant first pitch for receiving products such as pouches P dropped from knife 14. Preferably, buckets 18 are contiguous at this station.

After a bucket 18 is filled with a predetermined number of pouches, the assemblies 20 are conveyed by conveyor 30 in a downstream direction, during which individual buckets are formed into one of a variety of groups such as three bucket groups (FIG. 1), two-bucket groups (FIG. 2) or one-bucket groups (FIG. 3). Each of such groups, respectively, is oriented via conveyor 30 on a group pitch, equivalent to the pitch of cartons into which the respective groups are to be placed. Such group and carton pitch is typically different than the pitch of buckets when conveyed under knife 14 for product loading into the buckets.

Conveyor 30 is thus programmed to move buckets at a first one pitch under knife 14 in a downstream direction and in groups of one or more multiple buckets at a second or different pitch, equal to and corresponding to that of cartons moving approximately alongside the groups, and as illustrated in the drawings.

Thus, conveyor 30 is operable to convey buckets along a path and in variable pitch and orientation with movement of buckets in the groups downstream of knife 14 separate and independent from movement and pitch of buckets at the knife 14.

These and other advantages and modifications will become readily apparent to those of ordinary skill in the art without departing from the scope of the invention and applicant intends to be bound only by the claims appended hereto.

What is claimed is:

1. A packaging apparatus comprising, in combination:
a product receiving station wherein separate product buckets are loaded with one, or a stack of articles to be packaged;
a cartoning station wherein products from one or more selectively grouped buckets are introduced into a carton receiving said products from said one or more grouped buckets, the pitch of said grouped buckets at said cartoning station being different than the pitch of individual buckets loading at said product receiving station; and
a linear motor conveyor conveying buckets in a path from said product receiving station to said cartoning station independently of other buckets in said path, said path extending through said product receiving at cartoning stations.

2. Apparatus as in claim 1 wherein buckets receiving articles at said product receiving area are spaced at a first pitch responsive to the operation of a direct drop knife.

3. Apparatus as in claim 2 wherein buckets in said cartoning station are in groups at a respective pitch differing from the first pitch between buckets in said product receiving station.

4. Apparatus as in claim 1 wherein said linear motor conveyor includes a plurality of moving magnet linear motors including multiple, independently controlled moving carts carrying respective buckets and operating in a single path.

5. Apparatus as in claim 9 wherein the linear motors are programmed to specifically meet the bucket pitch requirements of the product receiving station.

6. Apparatus as in claim 5 wherein the linear motors are programmed to specifically meet the bucket and grouping pitch requirements of the cartoning station.

7. Apparatus as in claim 1 wherein said product receiving station includes a direct drop knife dropping articles into buckets in said path.

8. Apparatus as in claim 7 wherein said buckets are moved along said path independently of other buckets in said path from said direct drop knife to said cartoning station.

9. Apparatus as in claim 8 wherein said buckets are moved in said path with at least some of said buckets spaced apart from others of said buckets at varied distances from each other.

10. Transport apparatus for transporting pouches dropped directly from a rotary pouch transfer onto pouch receiving buckets moveable in a path defined by a bucket conveyor, wherein individual buckets are moveable along said path independently of other buckets in said path with variable spacing between buckets in said path,
said buckets independently and respectively moveable into a first position for receiving one or more pouches dropping directly into respective buckets in said first position from said rotary pouch transfer, and
after receiving one or more products said buckets being moveable along said path, independently of other buckets in said path, to a downstream cartoning station defining a second position operatively associated with said path, and at a bucket spacing different from bucket spacing in said first position.

11. Transport apparatus as in claim 10 wherein said bucket conveyor comprises a plurality of moving magnet linear motors driving multiple independent buckets.

12. Transport apparatus as in claim 11 wherein said buckets are carried in said path on said conveyor by respective independently controlled moving elements driven by said linear motors and traveling in said pattern.

13. Transport apparatus as in claim 12 wherein said moving elements are programmed to meet bucket pitch and grouping required at said first position.

14. Transport apparatus as in claim 12 wherein said moving elements are programmed to meet bucket pitch and grouping required at said second position.

15. Transport apparatus as in claim 12 wherein bucket or moving element pitch varies in discrete portions of said path.

16. A method of packaging including the steps of:
loading individual articles at a loading station into separate buckets carried by a bucket conveyor, said buckets operably oriented at a first pitch for receiving said articles and responsive to said loading;
transporting said buckets to a cartoning station; while
grouping buckets for carton loading at said cartoning station;
said grouping including forming groups of buckets, each group at a second group pitch different than said first pitch; and
transferring articles from said groups to respective cartons conveyed at said second pitch.

17. A method as in claim 16 wherein said transporting and grouping steps are carried out on a linear motor conveyor.

18. A method as in claim 17 comprising the step of transferring articles from said bucket groups across respective guides spaced at said second pitch.

19. A method as in claim 16 including varying the number of buckets in a group for cartoning varying product stacks in respective cartons.
